(19) United States
(12) Patent Application Publication
(10) Pub. No.: US 2004/0098604 A1
(43) Pub. Date: May 20, 2004

(54) Access protection system for serial bus systems and method for protecting computers against an unauthorized connection of peripheral devices

(76) Inventor: Detlev Noldge, Laer (DE)

Correspondence Address: LERNER AND GREENBERG, PA, P O BOX 2480, HOLLYWOOD, FL, 33022-2480, US

(21) Appl. No.: 10/703,064

(22) Filed: Nov. 6, 2003

(30) Foreign Application Priority Data
Nov. 6, 2002 (DE) 102 51 642.1

(51) Int. Cl. G06F 12/14

(52) U.S. Cl. 713/193

(57) ABSTRACT

A computer has a serial bus system to which peripheral devices may be connected. The computer has an access protection system in which identifiers of peripheral devices may be registered. The identifier of the peripheral device is checked upon a connection of a peripheral device to the bus system and, depending on the registration of the identifier, the connection to the peripheral device is or is not enabled. A method for protecting computers against the unauthorized connection of peripheral devices to serial bus systems uses an access protection system for controlling access to the serial bus system. An identifier of the peripheral device is read out upon a connection of a peripheral device to the serial bus system and, depending on the registration of the identifier, the connection to the peripheral device is or is not enabled.

### BACKGROUND OF THE INVENTION

### FIELD OF THE INVENTION

The invention relates to a computer having a serial bus system to which peripheral devices may be connected, and to a method for protecting computers against the unauthorized connection of peripheral devices to serial bus systems.

Computers having serial bus systems, in particular those having hot-pluggable serial bus systems, allow peripheral devices of a wide variety of embodiments to be connected to the serial bus systems. The peripheral devices include, for example, data storage medium drives or digital cameras, keyboards and the like. When a peripheral device is connected to a serial port of this type, it is recognized and supported by the computer. That is to say, a connection is established between the peripheral device and the computer via the serial bus system.

The unlimited ability to connect peripheral devices to a serial bus system of this type, for example a hot-pluggable serial bus system, results in a security deficit in the field of computers of this type.

In order to compensate for the security deficit, the ports of serial bus systems may be activated and deactivated. That is to say, the port may only be utilized by a user when, for example, an administrator has activated that port or serial bus system on the computer. The serial bus system on this computer is otherwise not available to a user.

### SUMMARY OF THE INVENTION

It is accordingly an object of the invention to provide an access protection system for serial bus systems and a method for protecting computers against an unauthorized connection of peripheral devices which overcome the above-mentioned disadvantages of the prior art devices and methods of this general type, which extends the availability of existing serial bus systems and reduces the prevailing security deficit in the process.

With the foregoing and other objects in view there is provided, in accordance with the invention, a computer. The computer contains a serial bus system for connecting to peripheral devices, and an access protection system having identifiers of the peripheral devices registered therein and controlling an access to the serial bus system. The identifier of a peripheral device is checked when the peripheral device requests a connection to the serial bus system and, depending on a registration of the identifier, a connection to the peripheral device is enabled.

The object is achieved by a computer having a serial bus system to which peripheral devices may be connected. In the computer there is an access protection system (in which identifiers of peripheral devices may be registered) for the serial bus system. The identifier of the peripheral device is checked upon a connection of a peripheral device to the bus system and, depending on the registration of the identifier, the connection to the peripheral device is or is not enabled.

The object is likewise achieved by a method for protecting computers against the unauthorized connection of peripheral devices to serial bus systems. In the method, an access protection system (in which identifiers of peripheral devices may be registered) is used for protecting the serial bus system. The identifier of the peripheral device is read out upon a connection of a peripheral device to the serial bus system and, depending on the registration of the identifier, the connection to the peripheral device is or is not enabled.

According to the invention, only those peripheral devices that are already known to the computer or have already been registered in the computer may thus be connected to the computer and operated.

The invention has been developed in various embodiments and so, for example, it is not only possible to register a particular device having a particular identifier but, in an extended embodiment, it is possible to combine particular devices to form a group. The group may be, for example, the group of all memory boards, digital cameras, keyboards and other input devices, and many more.

In a further embodiment, it is possible to coordinate the enabling of the connection to a peripheral device not only with the registration of the identifier of the latter alone but, moreover, in a more finely tuned manner by the capability to set authorizations in the computer for a particular peripheral device in connection with a particular computer user.

In accordance with an added feature of the invention, the serial bus system is a USB and/or an IEEE 1394 system.

In accordance with another feature of the invention, the peripheral devices may be connected when the computer is switched on and/or off.

Other features which are considered as characteristic for the invention are set forth in the appended claims.

Although the invention is illustrated and described herein as embodied in an access protection system for serial bus systems and a method for protecting computers against an unauthorized connection of peripheral devices, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a configuration of a computer and a peripheral device; and

FIG. 2 is a flow chart showing an exemplary method sequence for access to a peripheral device.

### DESCRIPTION OF THE PREFERRED EMBODIMENTS

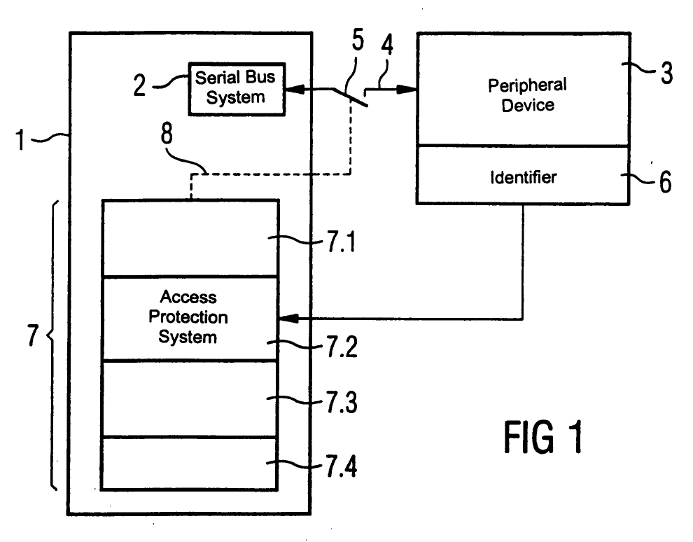

Referring now to the figures of the drawing in detail and first, particularly, to FIG. 1 thereof, there is shown a computer 1 that has a serial bus system 2. A peripheral device 3 may be connected to the computer by a connection 4. The connection 4 has an element 5 that enables a connection between the peripheral device 3 and the serial bus system 2. The element 5 is symbolically represented by a make contact. The peripheral device 3 has an identifier 6. The identifier 6 is unique and makes it possible to identify each peripheral device. If the peripheral device 3 has already been registered on the computer 1, an access protection system 7 fitted in the computer recognizes the peripheral device 3 by use of the identifier 6 and, via a functional path 8, instructs the element 5 to enable the connection 4.

If the peripheral device 3 is not known to the access protection system 7, no registration of the identifier 6 is located in the access protection system 7 either. When a peripheral device of this type is connected, the access protection system 7, via the functional path 8, instructs the element 5 not to enable the connection 4 between the peripheral device 3 and the serial bus system 2 of the computer 1.

In one development of the access protection system, the identifier 6 is registered in the access protection system 7 in such a manner that groups of peripheral devices are recognized and combined by the identifier 6, and the access protection system 7 enables the connection 4 for known groups of peripheral devices, or groups of peripheral devices which have been registered in the access protection system 7, by the functional path 8 and the element 5. The illustrated embodiment of the access protection system 7 has locations (7.1 to 7.4) at which it is possible to store not only the identifier 6 but also other parameters that are relevant to the enabling of the connection 4. The parameters may be, for example a particular user who is recognized and registered by his/her user name, a particular point in time at which access via the serial bus system is to be enabled, particular groups of devices which have in turn for their part been combined to form classes, and many more.

Many different combination options are conceivable using many different parameters. The above-mentioned list in this case constitutes only some of the numerous possibilities.

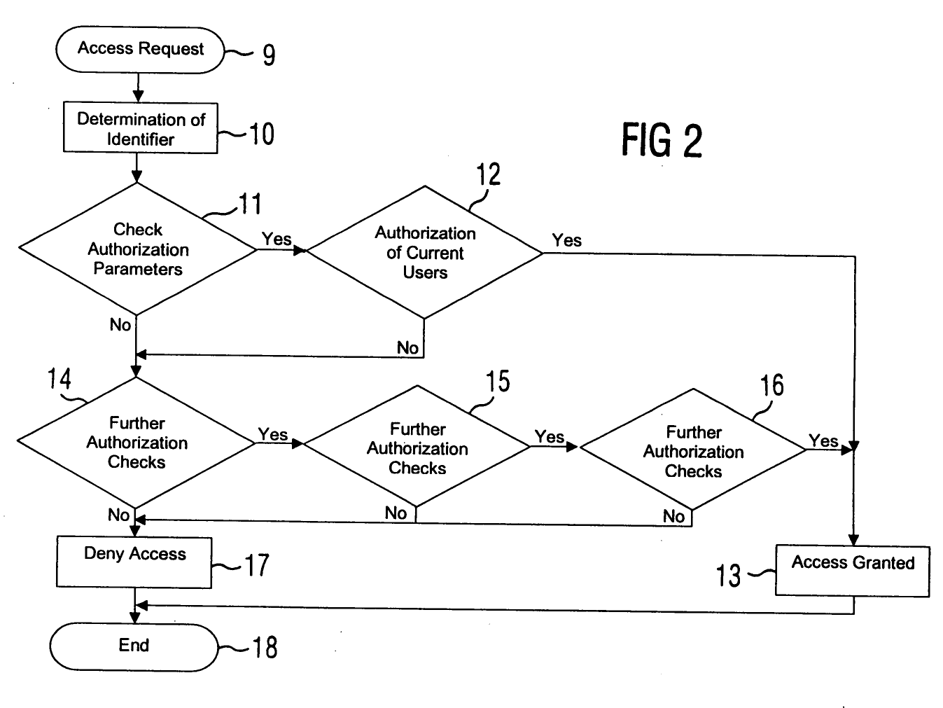

FIG. 2 shows, by way of example, an inventive method sequence in which access 9 to the serial bus system first triggers determination 10 of the identifier 6 and a comparison 11 then takes place which, for example, checks the authorization parameters 7.1 to 7.4 for peripheral devices 3 having the identifier 6 and, if the result is positive, initiates a further comparison 12 with the authorizations of the current user, with access 13 to the peripheral device 3 also being enabled in this case if the result is positive. If comparison 11 or comparison 12 leads to a negative result, a further checking level (the comparisons 14, 15 and 16) is provided by way of example in this method, with specific rights for the current user with regard to the class of the connected peripheral device 3 and with regard to the unique identifier 6 of the peripheral device 3 being implemented. If these comparisons 14, 15 and 16 lead to a positive result, access 13 to the peripheral device 3 is allowed, but if only one of these three comparisons 14, 15 and 16 leads to a negative result, access to the peripheral device 3 is denied by way of the “deny access” step 17.

The invention is advantageously suitable for peripheral devices 3 and serial bus systems that may be connected even while the computer is operating. Since, according to the invention, the identifier 6 is compared by the access protection system 7 before the connection 4 between the serial port 2 and the peripheral device 3 is enabled, it is in principle of no importance to the operation of the access protection system whether the peripheral device 3 is connected to the computer 1 while the latter is operating or while it is shot down.

I claim:

1. A computer, comprising:
a serial bus system for connecting to peripheral devices; and
an access protection system having identifiers of the peripheral devices registered therein and controlling an access to said serial bus system, an identifier of a peripheral device being checked when the peripheral device requests a connection to said serial bus system and, depending on a registration of the identifier, a connection to the peripheral device is enabled.

2. The computer according to claim 1, wherein said serial bus system is at least one of a USB and an IEEE 1394 system.

3. The computer according to claim 1, wherein authorizations for connections to particular peripheral devices may be set in the computer.

4. The computer according to claim 1, wherein it is possible to register an identifier as a group identifier for a group of peripheral devices.

5. The computer according to claim 1, wherein the peripheral devices may be connected when the computer is switched on and/or off.

6. A method for protecting a computer against an unauthorized connection of peripheral devices to a serial bus system, which comprises the steps of:
providing an access protection system having identifiers of the peripheral devices registered therein for connecting to the serial bus system;
reading out an identifier of a peripheral device upon a connection of the peripheral device to the serial bus system; and
enabling a connection to the peripheral device in dependence on a registration of the identifier in the access protection system.

7. The method according to claim 6, which further comprises before the connection to the peripheral device is enabled, checking authorizations which have been set in the computer for the connection and the connection is enabled depending on the authorizations.

8. The method according to claim 6, which further comprises combining the peripheral devices into groups of peripheral devices.

9. The method according to claim 6, which further comprises allowing the peripheral devices to connect to the computer when the computer is switched on and when the computer is switched off.

10. The method according to claim 6, which further comprises:
before data is interchanged with the peripheral device, checking, using the access protection system, at least one of the identifier of the peripheral device and the authorizations for the connection to the peripheral device; and
enabling an interchange of data depending on the identifier and on the authorization.
